(19) United States
(12) Patent Application Publication
(10) Pub. No.: US 2012/0315023 A1
(43) Pub. Date: Dec. 13, 2012

(54) CAPILLARY COLUMN CURING SYSTEM

(75) Inventors: David Collins, Celbridge (IE); Ekaterina Nesterenko, Dublin (IE); Brendan Heery, Kells (IE); Brett Paull, Hobart (AU)

(73) Assignee: DUBLIN CITY UNIVERSITY, Dublin (IE)

(21) Appl. No.: 13/490,256

(22) Filed: Jun. 6, 2012

(30) Foreign Application Priority Data
Jun. 7, 2011 (GB) 1109528.8

(51) Int. Cl. F27D 19/00; F27D 11/12; F27B 9/36

(52) U.S. Cl. 392/411; 392/417; 392/422; 432/49

(57) ABSTRACT

A curing system comprising an oven which may be usefully employed in the fabrication of long polymer columns of various morphologies and formats is described. In accordance with an exemplary arrangement the invention relates to a curing system comprising an oven that allows for the formation of very long capillary columns.

### FIELD OF THE INVENTION

The present invention relates to capillary columns and in particular to methods and apparatus for the fabrication of capillary columns. The invention more particularly relates to a curing system comprising an oven which may be usefully employed in the fabrication of long polymer columns of various morphologies and formats. In accordance with an exemplary arrangement the invention relates to a curing system that allows for formation of very long capillary columns.

### BACKGROUND

Known techniques for fabrication of columns include those employing either ultraviolet (UV) or thermal curing processes. UV curing requires that UV-transparent capillaries be used throughout the fabrication process; this introduces problems in that these capillaries are not as structurally sound as conventional capillaries, i.e., those with polyimide coating. Thermal curing is an exothermic reaction, and as the length of the capillary increases, it becomes increasingly difficult to dissipate the heat generated during the unstirred polymerisation. This leads to heterogeneities in the pore structure. Silica-based monoliths are prepared in PEEK moulds then attached to stationary phases. Due to shrinkage, preparation of straight rods of longer than 15 cm is difficult. There are therefore difficulties with both known techniques in fabrication of long columns.

### SUMMARY

These and other problems are addressed in accordance with the present teaching by a curing system comprising an oven that allows the manufacture of long polymer monolithic columns of various morphologies and formats. In a preferred arrangement the oven comprises a plurality of individual light sources that are circumferentially arranged about a capillary path through which a capillary may be fed through the oven. The capillary path is desirably co-located with a central axis of the oven. By providing a capillary within the oven it is possible to form a column within that capillary. In one arrangement the light sources are selected so as to provide an ultra violet (UV) curing of the column. In another configuration the light sources are infra red (IR) light sources that provide an IR photo-initiation process.

In another configuration, both UV and IR sources are provided such that a user may select which type of photoinitiated reaction is desired for the preparation of polymeric stationary phases.

The oven defines an illumination or curing chamber having first and second faces at opposing ends of the chamber. Desirably each of the first and second faces defines a port through which a capillary may pass. The capillary path links each of the ports defined in the first and second faces and is orientated within the chamber so as to have a longitudinal axis that is substantially parallel with a longitudinal axis of the capillary. In this way the capillary may be maintained substantially straight during its passage within the curing chamber.

By providing a plurality of individual light sources circumferentially about the capillary path it is possible to illuminate the introduced capillary evenly from all directions so as to provide uniform exposure about the capillary. Such illumination from sources arranged circumferentially about the capillary allows for the formation of a column within the capillary having a substantially uniform profile across is cross sectional area. The light sources are desirably narrow band output such as may be provided by a single output UV light emitting diode (LED) or an IR LED

To allow for a controlled feeding of the capillary, the curing system desirably comprises feed means which are configured to constrain the movement of the capillary during its passage through the oven. In a first configuration the feed means comprises a set of guide rollers fitted on either end of the oven, making it possible to feed a length of capillary through the oven. This allows very long (>10 m) capillary columns to be manufactured, such as ones that may be usefully employed in gas chromatography (GC) for example. It will be appreciated that the feed means described are exemplary of the type of apparatus that may be usefully employed in providing a controlled passage of a capillary through the oven. By judiciously selecting appropriate feed means it is possible to provide a variance in the draw speed of the capillary and this may be usefully employed in varying the ultimate properties of the column that is formed during the UV curing process.

The use of LEDs allows for a controlled variance of the intensity of the light that is used as part of the irradiation curing process. This intensity parameter is an example of the type of parameter that may be varied in accordance with the present teaching. Other examples include the illumination period, and wavelength of the incident light. In another arrangement, one or more of the plurality of provided light sources may be provided in a pulse configuration, and optionally, and the pulse frequency of the light could also be changed.

The curing system may comprise a light detector which is configured to monitor the curing environment within the curing chamber. Such a detector may comprise a photodiode. By suitably coupling the output of the light detector to a control module, it is possible to provide a feedback control to enable the conditions within the curing chamber to be varied as needed.

In a first configuration the curing chamber is air filled. In another configuration the curing chamber comprises a solid element such as provided by a UV or IR transparent substrate. The substrate may be configured to allow an optical coupling of the plurality of light sources to a first surface of the substrate so as to allow an introduction of light from the plurality of light sources into the substrate. The substrate may additionally define the capillary path within the substrate medium such that an introduced capillary will be located within the substrate during at least part of its passage through the curing chamber.

These and other features of the present teaching will be better understood with reference to the exemplary arrangements which follow.

### BRIEF DESCRIPTION OF THE DRAWINGS

FIG. 1 shows an example of a light source that may be usefully employed within the context of the present teaching.

FIG. 2A shows an example of a curingoven which may be for example a UV/IR curing oven in accordance with the present teaching.

FIG. 2B is a section through the line A-A of FIG. 2A.

FIG. 3 is an example of components of a curing system in accordance with the present teaching including an oven and feed means.

FIG. 4 shows an exemplary curing system from a first side.

FIG. 5 shows the curing system of FIG. 4 from another side.

FIG. 6 shows an example of a UV transparent substrate that may be usefully employed within the curing chamber of a curing system in accordance with the present teaching.

FIG. 7 is an SEM micrograph of a monoPLOT column manufactured using a curing system in accordance with the present teaching.

FIG. 8 is another SEM micrograph of a monoPLOT column manufactured using a curing system provided in accordance with the present teaching.

FIG. 9 is another SEM micrograph, this one showing a monolithic column fabricated with a curing system provided in accordance with the present teaching.

### DETAILED DESCRIPTION OF THE DRAWINGS

The following description is provided to assist the person of skill in understanding the present teaching but is not intended to limit the scope to the exemplary arrangements which are described. The following exemplary arrangements are illustrated with reference to an exemplary use of UV light sources but it will be appreciated that the present teaching may be extended to using IR light sources in combination with or instead of the described UV sources. In such an exemplary arrangement it is possible to use a system in accordance with the present teaching to photo polymerise in polyimide coated capillary (polyimide does not transmit UV) which is used in gas chromatography (GC) as it is more robust than teflon coated capillary for these applications. To provide such a photo-initiation regime it is possible to select where the IR sources are used or the UV sources are used. Certain configurations may or may not include sources of both types.

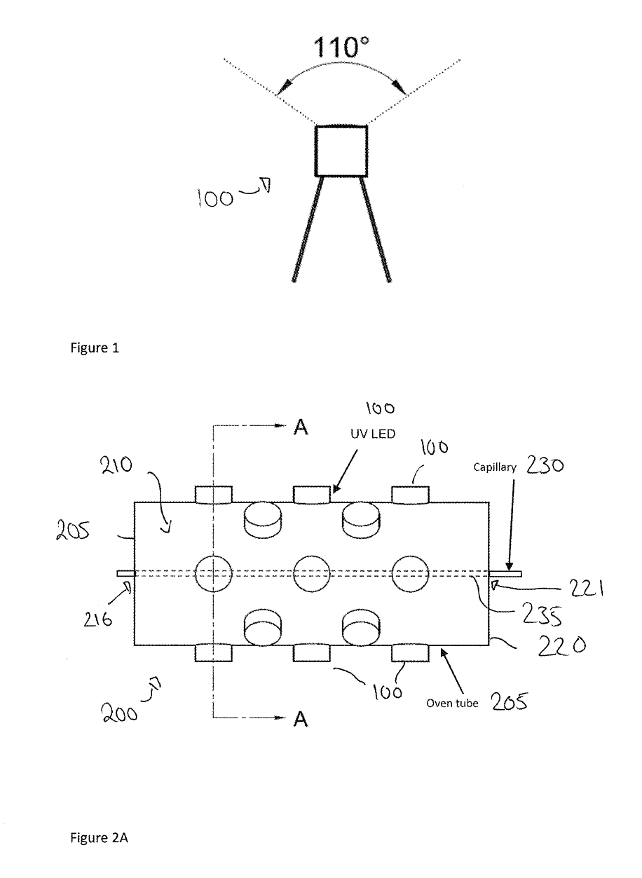

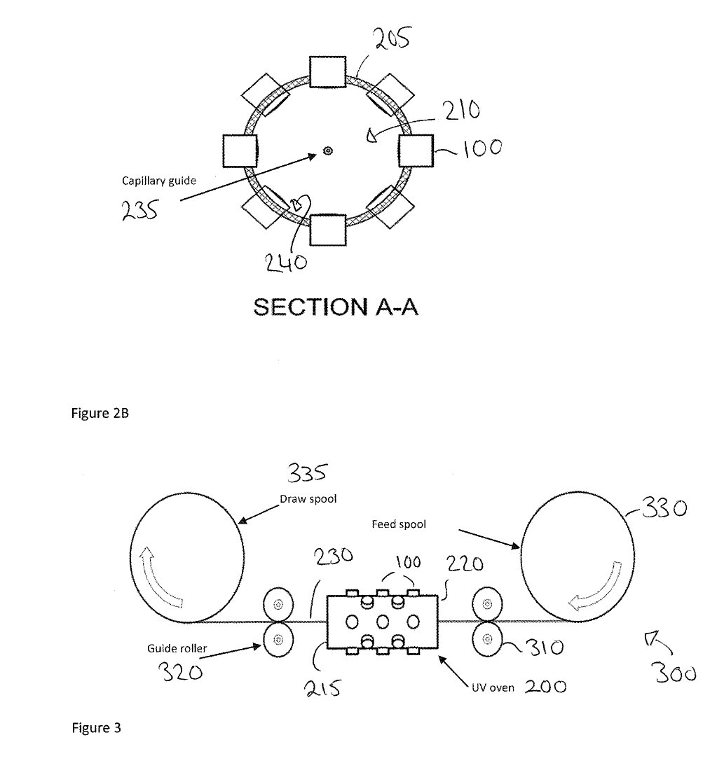

FIGS. 1 through 6 show examples of components that may be usefully employed within a curing system 300 (FIG. 3) provided in accordance with the present teaching. The system is configured to accommodate different media that may be polymerised through UV initiation, i.e. capillary columns etc., and is particularly configured to allow for a polymerisation of long lengths of capillary columns to form for example columns that may be usefully employed GC (gas chromatography). By providing a stationary curing chamber and allowing the capillary to be moved through that chamber in a controlled way as part of the curing process, the present teaching allows for long lengths (>10 m) of capillary columns to be manufactured. The dimensions of the curing chamber are desirably much less than that of the ultimate column length but in accordance with the present teaching the final capillary column is fabricated by a sequential feeding of portions of a capillary through the curing chamber thereby allowing for the formation of a capillary column of much greater lengths than the dimension of the curing chamber.

In an exemplary arrangement the curing system employs a plurality of individual light sources that are selected based on their narrow wavelength output. In this way the wavelength of light illuminating the column as part of the curing process is constrained within a narrow band. FIG. 1 shows an example of an exemplary light source that may be usefully employed within the context of the present teaching, a UV light emitting diode (LED) 100. The selected LED 100 provides a wide viewing angle, this exemplary device provides an output spanning 110° which allows for concurrent illumination of extended portions of a capillary using the same light source.

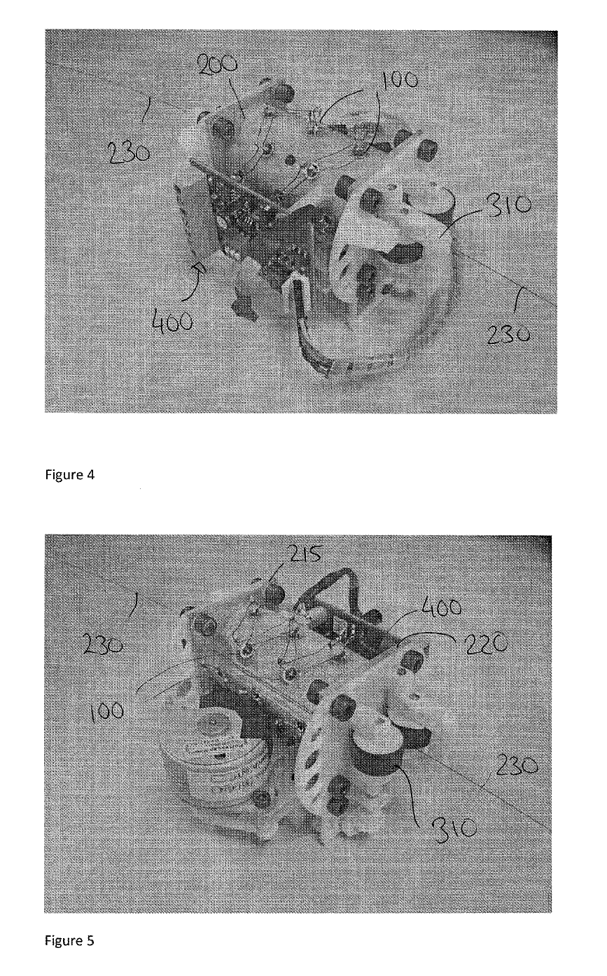

As shown in FIG. 2 the curing system comprises a UV oven 200 having a housing 205 provided in this exemplary arrangement in the form of a tube. The oven defines an illumination or curing chamber 210 located within an inner volume of the housing 205. The chamber is bordered by first 215 and second 220 faces at opposing ends of the oven housing 200, as shown in FIGS. 4 & 5 respectively. Each of the first and second faces defines a port 216, 221 through which a capillary 230 may pass. The ports are coupled to a capillary path 235 through which the capillary 230 may be fed through the oven. This capillary path or capillary guide 235 is desirably co-located with a central axis of the oven, as is evident from both the schematics of FIGS. 2A and 2B.

The capillary path 235 links each of the ports defined in the first and second faces and is orientated within the chamber so as to have a longitudinal axis that is substantially parallel with a longitudinal axis of the capillary. In this way the capillary may be maintained substantially straight during its passage within the curing chamber.

By providing a plurality of individual light sources 100 circumferentially about the capillary path it is possible to illuminate the introduced capillary from all directions so as to provide uniform exposure about the capillary which will allow for the fabrication of a column within the capillary. The light sources are desirably narrow band output such as may be provided by a single output UV light emitting diode (LED). The UV LEDs chosen for this oven have a wide viewing angle, meaning that they emit light from the face of the light source at a highly divergent angle. The capillary is passed through the centre of the oven, thus providing very uniform exposure along the length of the capillary, from all sides. The internal surfaces 240 of the oven are in this exemplary arrangement highly reflective, so a high percentage of the emitted light is directed towards the centre of the oven where the capillary is drawn through.

As shown in FIG. 3, to allow for a controlled feeding of the capillary, the curing system 300 desirably comprises feed means 310, 320 which are configured to constrain the movement of the capillary 230 during its passage through the oven 200. In the described exemplary arrangement, the feed means comprises a set of guide rollers 310, 320 fitted on either end of the oven, making it possible to feed a length of capillary through the oven. Each of the guide rollers may be coupled to a reel or spool 330, 335 to allow for a length of capillary to be drawn from a reel, passed through the curing chamber and then re-spooled onto another reel at the other end of the curing chamber. By feeding the capillary through the oven (the oven remains stationary, while the capillary is pulled through it) it allows the manufacture of columns of very long length. In this way, it is possible to allow for very long (>10 m) capillary columns to be manufactured, such as ones that may be usefully employed in gas chromatography (GC) for example. It will be appreciated that the motorised guide rollers of the described feed means described are exemplary of the type of apparatus that may be usefully employed in providing a controlled passage of a capillary through the oven. By judiciously selecting appropriate feed means it is possible to provide a variance in the draw speed of the capillary and this may be usefully employed in varying the ultimate properties of the column that is formed during the UV curing process. It will be appreciated that an adjustment of the draw speed allows the exposure time per unit length of the capillary to be accurately adjusted.

Use of this approach could also be modified to allow for performance of flow through UV reactions.

The use of UV LEDs allows for a controlled variance of the intensity of the light that is used as part of the irradiation curing process. This intensity parameter is an example of the type of parameter that may be varied in accordance with the present teaching. Other examples include the illumination period and frequency. In another arrangement, one or more of the plurality of provided light sources may be provided in a pulse configuration. It will be appreciated that the use of LEDs as the light source is highly advantageous as conventional bulbs—which have been traditionally used in UV curing chambers do not allow these parameters to be varied. These additional configurable settings give a high level of control to the polymerisation process.

The curing system may comprise a light detector which is configured to monitor the curing environment within the curing chamber. Such a detector may comprise a photodiode, which may be usefully employed in monitoring the intensity of the light. By suitably coupling the output of the light detector to a control module, shown in FIG. 4 as a component on the circuit board 400, it is possible to provide a feedback control to enable the conditions within the curing chamber 210 to be varied as needed. An example of the type of feedback configuration that may be used to control the output to the LEDs (i.e. the intensity of the light) is through use of a PID (Proportional Integral Derivative) loop.

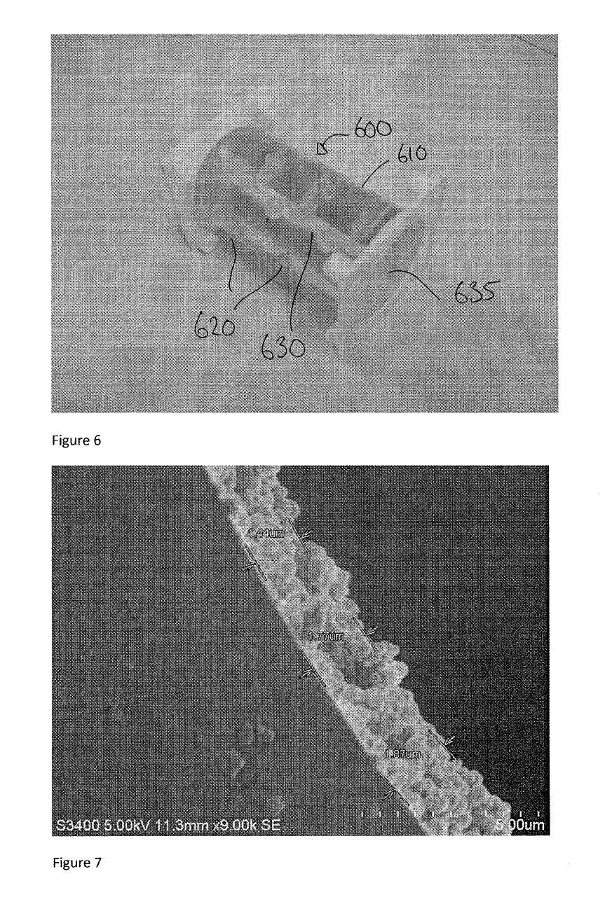

In a first configuration the curing chamber 210 is air filled. In another configuration shown in FIG. 6, the curing chamber may comprise a solid element 600 such as provided by a UV transparent substrate. This substrate also defines a capillary guide but whereas previously the capillary within the oven was surrounded by air, in this arrangement a UV transparent tube with a highly diffuse surface finish is provided within which the capillary passes. The properties of the substrate are selected to provide and ensure a homogenous exposure of a capillary to the incident light. It will be appreciated that the oven can be used with or without this solid element, depending on the capillary media being used. Where used, the substrate 600 is dimensioned to be received within the housing of the oven, and may be removable from same. The substrate is desirably configured to allow an optical coupling of the plurality of light sources to a first surface 610 of the substrate 600 so as to allow an introduction of light from the plurality of light sources into the substrate. An example of the optical coupling may comprise a plurality of individual dimples or recesses 620 that are formed in the first surface of the substrate—that being the outer surface. If provided, the substrate additionally defines the capillary path 630 within the substrate medium such that an introduced capillary will be located within the substrate during at least part of its passage through the curing chamber. The capillary path 630 includes an entrance port 635 and an exit port (not visible from the view of FIG. 6) that when the substrate is located within the chamber 200 are coincident with the ports 216, 221 formed in the first and second surfaces of the oven 200. It will be appreciated that the use of a solid substrate into which light is introduced prior to its incidence on the capillary provides a distributed lighting—the substrate forming a diffuser between the light sources and the capillary path.

Irrespective of the presence or not of a substrate within the curing chamber, the light sources are desirably radially configured away from the main axis of the chamber and are equidistant from that main axis. In this way the intensity of light along the length of the capillary path is desirably equal.

By judiciously selecting light sources it may be possible to tailor the illumination wavelength. For example 365 or 370 nm would be common wavelengths used for polymerisation and as such an exemplary light source may output light about 365 nm, It is also possible to get 254 nm LEDs or indeed those that provide light in the 600 nm range so it will be appreciated that the present teaching should not be restricted to one specific wavelength LED. What is important is that in accordance with the present teaching, highly specific wavelength output light sources may be advantageously employed.

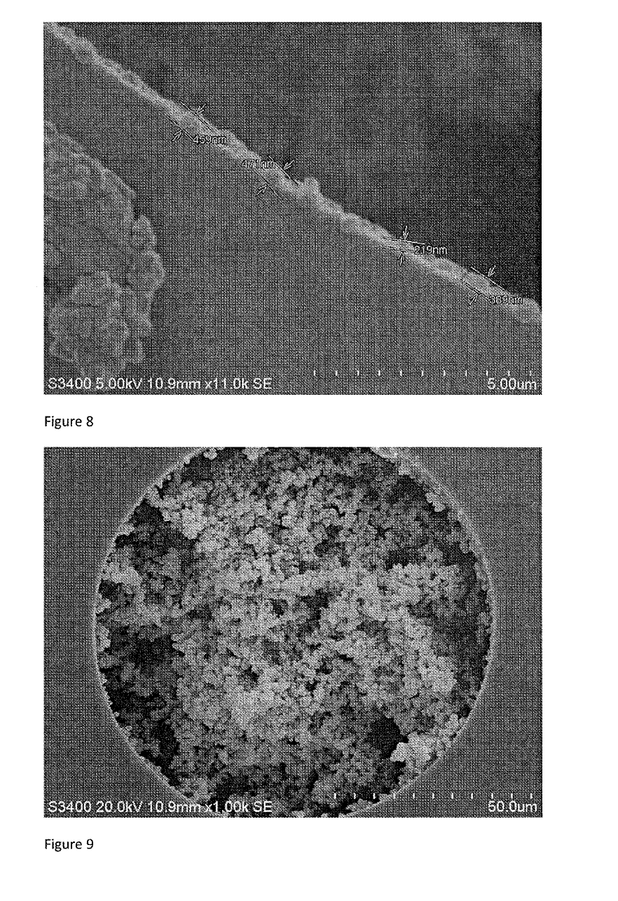

Tests conducted using a curing system provided in accordance with the present teaching. FIGS. 7 through 9 show exemplary SEM micrographs of manufactured columns provided in accordance with the present teaching. Use of a curing system in accordance with the present teaching allows fine control of the polymerisation process during monolith fabrication. FIGS. 7 and 8 show detail of different monolith formations that were fabricated using a system provided in accordance with the present teaching. In each monoPLOT (Monolithic Porous Layer Open Tubular) columns were fabricated with different layer thicknesses. FIG. 9 shows a further example whereby a monolithic column was produced with a coarse pore size.

It will be appreciated that a curing system provided in accordance with the present teaching has numerous advantages over prior art systems. For example a system in accordance with the present teaching allows a capillary to be drawn through the oven, thus allowing very long capillaries to be used. Furthermore, the rate at which the capillary is drawn through the oven is user configurable.

The use of UV LEDs as the light source is highly advantageous as the intensity of the light can be controlled and can also be pulsed as required. This pulsing of the UV light source, and thus stopping and starting the reaction during the polymerisation process, can give a very high level of control of the polymerisation process. This system also provides closed loop control, monitoring and controlling the amount of UV radiation that is emitted. Furthermore, the high level of control of the UV light allows the production of highly reproducible monolithic monoPLOT columns, something that is extremely difficult with other approaches.

In addition, a system provided in accordance with the present teaching can also be used as a flow through UV reactor.

In this way a system in accordance with the present teaching may be advantageously employed in fabrication of polymer monolithic columns of different lengths, allowing the production of gas chromatography columns, which are usually over 10 m long. The fabrication of polymer monolithic capillary columns in different formats: fully polymerised, monoPLOT is also possible. Use of the tuning characteristics available using a system provided in accordance with the present teaching also allows for fabrication of polymer monolithic capillary columns with various morphologies: different pore size, or layer thickness in case on monoPLOT.

It will be understood that the foregoing has described aspects of the present teaching with reference to an exemplary arrangement using a UV source. In other configurations IR sources could be used instead of, or in combination with the UV sources described. IR photo-initiation is attractive for a number of reasons as it not only allows photo polymerisation in polyimide capillary, but also allows fabrication of stationary phases which cannot be prepared in by using UV initiation (such as polystyrene-divinylbenzene, PS-DVB, which is commonly used in GC). In terms of photo initiated PLOT columns, a PS-DVB phase in a polyimide capillary is very desirable.

To provide such a configuration additional LED light sources could be incorporated into the curing oven. Typical operational wavelengths would include those at 830 nm because that is close to the maximum absorbance of photo-initiators, however any IR light source in the near IR range would be suitable, depending on the type of initiator used. For example polyimide absorbs strongly up to around 660 nm, depending on the particular grade/manufacturer. In operation a device that effects photo-initiation using IR sources operates in the same way as that described with reference to the UV sources. The system is configured to provide for a drawing of the capillary in one end and through the curing oven. The only difference is that now the user may select what wavelength they want, depending on the initiator, type of capillary, and type of stationary phase they are fabricating.

It will be appreciated that both UV and IR approaches have merit. Certain applications such as provision of a PS-DVB phase in polyimide coated capillary is highly desirable and requires use of IR curing but there are many types of stationary phase and initiator that only work in the UV range and so must be fabricated in Teflon coated capillary. For example, typically speaking, any monoPLOT columns manufactured for LC tends to have a smaller internal diameter, and so a UV source would be optimally used in combination with a methacrylate stationary phase. For GC, we need a much wider bore and perhaps a PS-DVB stationary phase, so would use polyimide coated capillary, initiated by IR. Having both UV and IR sources on the device is advantageous in that nearly all of the photoinitiated reactions commonly used for the preparation of polymeric stationary phases could be effected using a system provided in accordance with the present teaching.

It will be appreciated therefore that while exemplary methodologies and devices have been described heretofore that these are provided simply to assist in an understanding of the teaching and benefits of the present invention. Modifications can be made without departing from the spirit and the scope of the presently claimed invention. Integers and steps that are described with reference to one Figure may be interchanged or replaced with those of another Figure without departing from the present teaching.

The words comprises/comprising when used in this specification are to specify the presence of stated features, integers, steps or components but does not preclude the presence or addition of one or more other features, integers, steps, components or groups thereof.

1. A capillary column curing system comprising an oven defining a capillary path through which a capillary may be fed through a curing chamber of the oven, the system further comprising a plurality of individual light sources circumferentially arranged about the capillary path.

2. The system of claim 1 wherein the oven comprises a housing defining an interior volume within which the curing chamber is located.

3. The system of claim 1 wherein the capillary path is co-located with a central axis of the curing chamber.

4. The system of claim 3 wherein the curing chamber comprises first and second faces at opposing ends of the chamber, each of the first and second faces defining a port through which a capillary may pass.

5. The system of claim 4 wherein the capillary path links each of the ports defined in the first and second faces and is orientated within the chamber so as to have a longitudinal axis that is substantially parallel with a longitudinal axis of the capillary.

6. The system of claim 1 wherein the light sources are narrow band output devices such as light emitting diodes (LED).

7. The system of claim 1 wherein the light sources are radially spaced apart from the capillary path, each of the light sources being equidistant from a longitudinal axis of the capillary path.

8. The system of claim 2 wherein interior surfaces of the interior volume are polished to provide a reflective surface.

9. The system of claim 1 wherein the curing chamber is air filled.

10. The system of claim 1 wherein the curing chamber comprises a solid element, the solid element configured to allow an optical coupling of the plurality of light sources to a first surface of the solid element so as to allow an introduction of light from the plurality of light sources into the solid element.

11. The system of claim 10 wherein the solid element defines the capillary path within the substrate medium such that an introduced capillary will be located within the solid element during at least part of its passage through the curing chamber.

12. The system of claim 10 wherein the solid element comprises a UV/IR transparent substrate.

13. The system of claim 1 comprising feed means configured to constrain a movement of the capillary during its passage through the oven.

14. The system of claim 13 wherein the feed means comprises a set of guide rollers fitted on either end of the oven, making it possible to feed a length of capillary through the oven.

15. The system of claim 13 wherein the feed means are configured to allow a variance in the draw speed of the capillary through the chamber.

16. The system of claim 1 wherein the light sources comprise LEDs coupled to a controller to operably allow for a controlled variance of the intensity of the light that is used as part of the irradiation curing process.

17. The system of claim 16 wherein the controller is configured to provide a variation in one or more parameters relating to illumination period and frequency.

18. The system of claim 16 wherein one or more of the plurality of provided light sources is provided in a pulse configuration.

19. The system of claim 1 comprising a detector configured to monitor a curing environment within the curing chamber.

20. The system of claim 19 wherein the detector comprises a photodiode.

21. The system of claim 19 wherein the output of the detector is coupled to a control module thereby providing a feedback control to enable conditions within the curing chamber to be varied as needed.

22. The system of claim 1 comprising one or more ultraviolet light sources.

23. The system of claim 1 comprising one or more infrared light sources.

24. The system of claim 1 comprising individual ultraviolet and infrared light sources.

25. The system of claim 24 comprising a controller configured to allow a user select which of the individual ultraviolet and infrared are activated.
